(19) United States
(12) Patent Application Publication
(10) Pub. No.: US 2026/0210319 A1
(43) Pub. Date: Jul. 23, 2026

(54) ELECTROMAGNETIC ACTUATOR AND FUEL INJECTION DEVICE

(71) Applicant: MITSUBISHI HEAVY INDUSTRIES ENGINE & TURBOCHARGER, LTD., Sagamihara-shi, Kanagawa (JP)

(72) Inventor: Hisao OGAWA, Sagamihara-shi (JP)

(73) Assignee: MITSUBISHI HEAVY INDUSTRIES ENGINE & TURBOCHARGER, LTD., Sagamihara-shi, Kanagawa (JP)

(21) Appl. No.: 19/157,736

(22) PCT Filed: Jan. 23, 2024
(86) PCT No.: PCT/JP2024/001800

§ 371 Date: Aug. 19, 2025

(30) Foreign Application Priority Data
Mar. 10, 2023 (JP) 2023-037974

(51) Int. Cl. F02M 51/06; F02M 61/20

(52) U.S. Cl. CPC F02M 51/0614; F02M 61/20

(57) ABSTRACT

One aspect of an electromagnetic actuator according to the present disclosure includes: a stator core which is disposed within a casing of a fuel injection device and has a built-in coil for generating a magnetic flux when energized; an armature which has a facing surface disposed to face one end surface of the stator core in an axial direction of the casing and has a first through hole extending along the axial direction, the armature being capable of reciprocating along the axial direction depending on the presence or absence of electromagnetic force generated from the stator core; a valve body which is inserted into the first through hole and has a flange part formed at a protruding part protruding from the first through hole toward the stator core with a larger diameter than that of the first through hole, the valve body being capable of opening and closing an outlet port of a back pressure chamber formed in the casing; and a first spring member which biases the valve body along the axial direction in a direction that closes the outlet port.

### TECHNICAL FIELD

The present disclosure relates to an electromagnetic actuator and a fuel injection device including the electromagnetic actuator.

The present application claims priority based on Japanese Patent Application No. 2023-037974 filed on Mar. 10, 2023, the entire content of which is incorporated herein by reference.

### BACKGROUND ART

Electronically controlled fuel injection systems are widely used in diesel engines, including common rail systems. In electronically controlled fuel injection systems, fast-response electromagnetic valves are often used to control fuel injection. As a general structure, such an electromagnetic valve includes a stator core having a built-in solenoid coil, and an armature made of magnetic material opposite the stator core, and is configured such that the armature is lifted by electromagnetic force generated by energizing the solenoid coil, and a valve body connected to the armature is lifted accordingly to open a fuel passage. Patent Documents 1 and 2 disclose fuel injection devices with the configuration as described above.

### CITATION LIST

### Patent Literature

Patent Document 1: JPH10-018934A
Patent Document 2: JP2010-159734A

### SUMMARY

### Problems to be Solved

In the fuel injection devices disclosed in Patent Documents 1 and 2, the armature and the valve body are formed integrally, and the armature and the valve body operate in unison. As the time during which the solenoid coil is energized increases, the amount of movement of the armature increases as well as the lift of the valve body increases, but when the armature comes into contact with the stator core, an abrupt movement in the valve-closing direction is generated due to a repulsive force received from the stator core. Therefore, the valve body, which had been exhibiting a parabolic motion until that point, shifts to an abrupt valve-closing motion when the armature comes into contact with the stator core. As a result, the relationship between the fuel injection amount and the energization time changes from an increasing slope to a decreasing slope, resulting in a deterioration of fuel injection controllability.

The present disclosure was made in view of the above circumstances, and an object thereof is to suppress the abrupt valve-closing motion that occurs when the armature comes into contact with the stator core, as described above, thereby suppressing the deterioration of fuel injection controllability.

### Solution to the Problems

In order to achieve the above-described object, one aspect of the present disclosure provides an electromagnetic actuator installed in a fuel injection device, including: a stator core which is disposed within a casing of the fuel injection device and has a built-in coil for generating a magnetic flux when energized; an armature which has a facing surface disposed to face one end surface of the stator core in an axial direction of the casing and has a first through hole extending along the axial direction, the armature being capable of reciprocating along the axial direction depending on the presence or absence of electromagnetic force generated from the stator core; a valve body which is inserted into the first through hole and has a flange part formed at a protruding part protruding from the first through hole toward the stator core with a larger diameter than that of the first through hole, the valve body being capable of opening and closing an outlet port of a back pressure chamber formed in the casing; and a first spring member which biases the valve body along the axial direction in a direction that closes the outlet port. The valve body is disposed slidably along the axial direction in a state where the valve body is inserted into the first through hole. The electromagnetic actuator is configured such that, when the armature moves toward the stator core along the axial direction, the facing surface of the armature comes into contact with the flange part, whereby the valve body is moved in a direction that opens the outlet port.

One aspect of the present disclosure provides a fuel injection device including the above-described electromagnetic actuator.

### Advantageous Effects

According to one aspect of the electromagnetic actuator and the fuel injection device of the present disclosure, the valve body is inserted into the first through hole and can slide freely along the axial direction with respect to the armature. This suppresses the abrupt valve-closing motion of the valve body in conjunction with the armature, even when the coil is energized to inject fuel from the fuel injection hole into the combustion chamber, and the armature comes into contact with the stator core and receives from the stator core a repulsive force that causes the armature to move abruptly away from the stator core. Therefore, it is possible to suppress the deterioration of fuel injection controllability.

### BRIEF DESCRIPTION OF DRAWINGS

FIG. 1 is a schematic longitudinal cross-sectional view of a fuel injection device according to an embodiment.

FIG. 2 is a longitudinal cross-sectional view of an electromagnetic actuator according to an embodiment incorporated in the fuel injection device shown in FIG. 1.

FIG. 3 is an enlarged longitudinal cross-sectional view of a part of an electromagnetic actuator according to another embodiment.

FIG. 4 is an enlarged longitudinal cross-sectional view of a part of an electromagnetic actuator according to yet another embodiment.

FIG. 5 is a graph showing the relationship between the fuel injection amount and the time the coil is energized in the fuel injection device.

### DETAILED DESCRIPTION

Embodiments of the present invention will now be described in detail with reference to the accompanying drawings. It is intended, however, that unless particularly identified, dimensions, materials, shapes, relative positions, and the like of components described in the embodiments shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

### Configuration of Fuel Injection Device

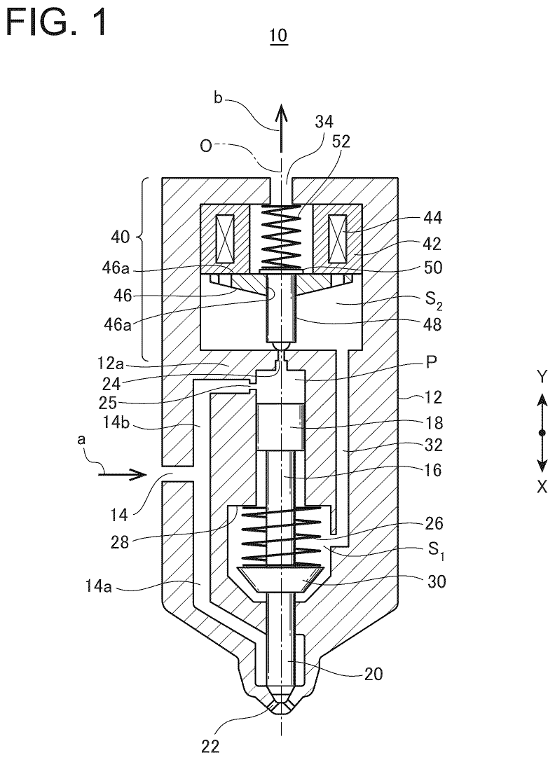

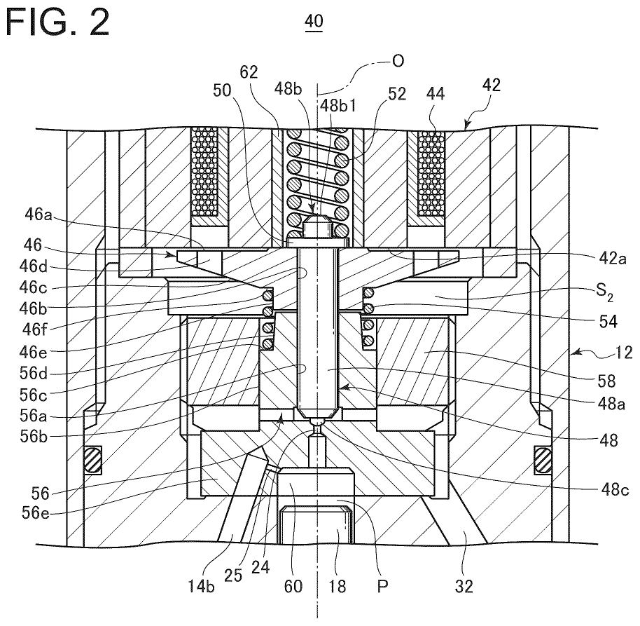

FIG. 1 is a schematic longitudinal cross-sectional view of a fuel injection device according to an embodiment of the present disclosure. FIG. 2 is a longitudinal cross-sectional view of a part of the fuel injection device shown in FIG. 1 and a longitudinal cross-sectional view of an electromagnetic actuator according to an embodiment of the present disclosure.

In FIG. 1, a fuel passage 14 is formed in a casing 12 of the fuel injection device 10. High-pressure fuel is supplied to the fuel passage 14 from a high-pressure fuel line (not shown), as indicated by arrow a. For example, when the fuel injection device 10 is applied to a common rail fuel injection system installed in a diesel engine, high-pressure fuel accumulated in a kind of surge tank, an accumulator pipe called a “common rail”, is supplied to the fuel passage 14.

A first space S₁ extending along the axis O of the casing 12 is formed inside the casing 12, and a spool 16 is arranged in the first space S₁. A piston 18 is provided at one end of the spool 16, and a needle valve 20 is provided at the other end. A plurality of injection holes 22 is formed at the tip of the casing 12, and the fuel passage 14 branches within the casing 12 into a fuel passage 14a communicating with the injection holes 22 and a fuel passage 14b communicating with a back pressure chamber P formed to face the piston 18. The reciprocating motion of the needle valve 20 together with the spool 16 along the axis O opens and closes the injection holes 22. Fuel under high pressure is injected into a combustion chamber (not shown) of the internal combustion engine through the open injection holes 22.

In FIG. 1, the tip side of the casing 12 with the injection holes 22 is defined as X direction, and the direction opposite to X direction is defined as Y direction.

An inlet orifice 25 leading from the fuel passage 14b to the back pressure chamber P is formed in the casing 12. A second space S₂ is formed adjacent to the first space S₁ on the Y-direction side thereof with a partition wall 12a interposed therebetween, and an outlet orifice 24 connecting the back pressure chamber P and the second space S₂ is formed in the partition wall 12a. In the second space S₂, an electromagnetic actuator 40 according to an embodiment of the present disclosure is installed to open and close the outlet orifice 24.

In the first space S₁, a spring member 26 is disposed at an axially middle portion of the spool 16, one end of the spring member 26 engages with a stepped part 28 formed on the inner wall of the casing 12 facing the first space S₁, and the other end of the spring member 26 engages with a support base 30 formed integrally with the spool 16 and extending in the radial direction of the casing 12 (hereinafter simply referred to as “radial direction”). The spring member 26 exerts a spring force on the spool 16 in a direction that the needle valve 20 closes the injection holes 22. When the electromagnetic actuator 40 closes the outlet orifice 24, the spool 16 is in the position to close the injection holes 22.

When the electromagnetic actuator 40 opens the outlet orifice 24, the back pressure chamber P communicates with the second space S₂, while the fuel flow from the fuel passage 14b is throttled (restricted) by the inlet orifice 25, so that the fuel pressure in the back pressure chamber P is reduced. As a result, the force that biases the spool 16 in X direction decreases, and the spool 16 moves in Y direction to open the injection holes 22, allowing the high-pressure fuel to be injected into the combustion chamber of the engine (e.g., diesel engine). The casing 12 has a leak passage 32 that connects the first space S₁ and the second space S₂. Fuel leaking from the fuel passages 14a and 14b into the first space S₁ flows from the first space S₁ through the leak passage 32 into the second space S₂. It is then discharged from the second space S₂ through an outlet 34 formed in the casing 12, as indicated by arrow b.

### Configuration of Electromagnetic Actuator

As shown in FIG. 2, the electromagnetic actuator 40 includes a stator core 42 disposed in the second space S₂. The stator core 42 is composed of magnetic material and has a built-in solenoid coil 44. When the solenoid coil 44 is energized, the solenoid coil 44 generates a magnetic flux, and an electromagnetic force is generated from the stator core 42. Further, an armature 46 is disposed on one side (in the embodiment illustrated in FIG. 2, on the X-direction side) of the stator core 42 in the axial direction of the casing 12 (hereinafter simply referred to as “axial direction”). The armature 46 has a facing surface 46a (in the embodiment illustrated in FIG. 1, the top surface of armature 46) disposed to face one end surface 42a of the stator core 42 (in the embodiment illustrated in FIG. 1, the bottom surface 42a of stator core 42), and a first through hole 46b extending along the axial direction. The armature 46 is capable of reciprocating along the axial direction depending on the presence or absence of electromagnetic force generated from the stator core 42. More specifically, when an electromagnetic force is generated from the stator core 42, the armature 46 is attracted to the stator core 42 along the axial direction.

Further, the electromagnetic actuator 40 includes a valve body 48 and a first spring member 52. The valve body 48 is inserted into the first through hole 46b and can slide feely along the axial direction within the first through hole 46b. With the reciprocating motion of the valve body 48 along the axial direction, the injection holes 22 are opened and closed. The valve body 48 has a protruding part 48b that protrudes from the first through hole 46b toward the stator core 42. The protruding part 48b has a flange part 50 with a diameter larger than the diameter of the first through hole 46b. The protruding part 48b and the flange part 50 are formed integrally with the valve body 48. The spring force of the first spring member 52 pushes the valve body 48 along the axial direction in a direction that closes the outlet orifice 24 (X direction).

In this configuration, when the solenoid coil 44 is not energized, the valve body 48 is held in the position to close the outlet orifice 24 by the spring force of the first spring member 52 applied to the valve body 48 (closed valve state). When the solenoid coil 44 is energized and a magnetic flux is generated from the solenoid coil 44 to generate an electromagnetic force from the stator core 42, an attractive force is generated that pulls the armature 46 toward the stator core 42. This attractive force causes the armature 46 to translate toward the stator core 42 along the extension direction of axis O. When the armature 46 moves toward the stator core 42, the facing surface 46a of the armature 46 comes into contact with the flange part 50 because the flange part 50 has a larger diameter than the first through hole 46b. Therefore, the valve body 48, which is integrated with the flange part 50, also moves against the spring force of the first spring member 52 to open the outlet orifice 24 (valve-opening motion).

As described above, since the valve body 48 is disposed slidably along the axial direction with respect to the armature 46 in a state where it is inserted into the first through hole 46b, even when the armature 46 comes into contact with the stator core 42 and receives a repulsive force that causes the armature 46 to move abruptly away from the stator core 42, this abrupt motion is not directly transmitted to the valve body 48. Thus, the valve body 48 is prevented from abruptly moving to close the valve in conjunction with the armature 46, and therefore it is possible to suppress the deterioration of fuel injection controllability.

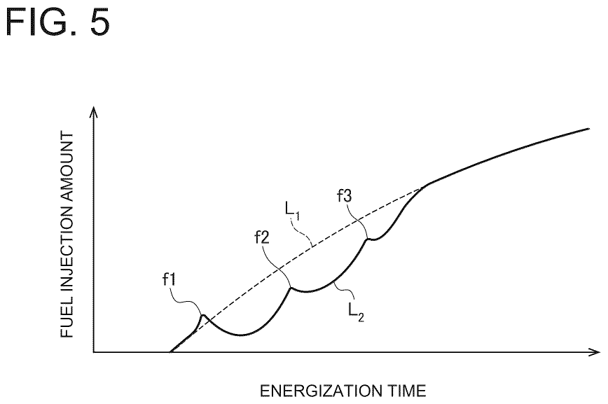

FIG. 5 is a graph showing the relationship between the energization time to the solenoid coil 44 and the fuel injection amount in the fuel injection device 10 equipped with the electromagnetic actuator 40 and a fuel injection device as disclosed in Patent Documents 1 and 2. In this figure, line L₁ represents the fuel injection amount of the fuel injection device 10, and line L₂ represents the fuel injection amount of the fuel injection device as disclosed in Patent Documents 1 and 2.

The amount of movement (lift) of the valve body 48 toward the stator core 42 increases parabolically as the energization time increases until the armature 46 comes into contact with the stator core 42, and the fuel injection amount also increases almost in proportion to the energization time. However, when the facing surface 46a of the armature 46 comes into contact with a facing surface 42a of the stator core 42, the armature 46 receives a repulsive force from the stator core 42 and moves abruptly in the valve-closing direction. Accordingly, in the fuel injection device in which the armature and valve body are integrally configured as disclosed in Patent Documents 1 and 2, the valve body 48 also moves abruptly in the valve-closing direction, so that the fuel injection amount transitions sharply from an increasing to a decreasing state, as indicated by line L₂. This leads to a deterioration of fuel injection controllability.

In FIG. 5, peaks f1, f2, and f3 in line L₂indicate the point at which the armature comes into contact with the stator core. In line L₂, the fuel injection amount drops sharply after peaks f1, f2 and f3.

In contrast, in the fuel injection device 10 according to the present embodiment, the armature 46 and the valve body 48 are not integrated, and the valve body 48 is disposed slidably with respect to the armature 46 in a state where it is inserted into the first through hole 46b. Therefore, even when the facing surface 46a of the armature 46 comes into contact with the facing surface 42a of the stator core 42 and receives a repulsive force from the stator core 42 that causes the armature 46 to move abruptly away from the stator core 42, this abrupt motion is not directly transmitted to the valve body 48. Therefore, the fuel injection amount maintains a smooth curve as indicated by line L₁ and does not drop sharply, thus suppressing the deterioration of fuel injection controllability.

In the embodiment illustrated in FIG. 2, the first spring member 52, the armature 46, the first through hole 46b, the valve body 48, and the protruding part 48b including the flange part 50 are arranged within the casing 12 so that their axes coincide with the axis O. Further, the mutually facing surfaces 42a and 46a of the stator core 42 and the armature 46 are formed by flat surfaces extending in the direction perpendicular to the axis O.

The first spring member 52 is disposed on the axis O in a space formed in a central portion of the stator core 42 and is configured as a coil spring extending along the axial direction.

The protruding part 48b is formed integrally with the valve body 48, has a cylindrical shape, and has a reduced diameter part 48b1 with a smaller diameter than those of the flange part 50 and a shaft part 48a of the valve body 48, which will be described below. The reduced diameter part 48b1 is inserted into the space formed inside the first spring member 52. The flange part 50 is formed between the protruding part 48b and the valve body 48, and is configured as a disc with a larger diameter than those of the reduced diameter part 48b1 and the shaft part 48a. The reduced diameter part 48b1 and the flange part 50 may be composed of magnetic or non-magnetic material. For example, if they are composed of wear-resistant material, wear can be reduced.

In the embodiment illustrated in FIG. 2, the first through hole 46b formed in the armature 46 is circular in transverse cross-section and extends in the axial direction on the axis O. The valve body 48 has a cylindrical shaft part 48a disposed along the axial direction on the axis O, and the shaft part 48a is inserted into the first through hole 46b and is slidably disposed within the first through hole 46b. The tip of the valve body 48 at the side opposite from the flange part 50 has a protrusion 48c for opening and closing the outlet orifice 24 by being brought into contact with or moving away from the valve seat formed on the partition wall 12a that forms the outlet orifice 24.

The armature 46 has a disc shape that enlarges radially outward from the first through hole 46b, and a leak hole 46d penetrating the facing surface 46a and a back side 46c opposite to the facing surface 46a is formed in the enlarged portion. Leaked fuel that flows from the first space S₁ into the second space S₂ through the leak passage 32 passes through the leak hole 46d and flows out from the outlet 34 in the direction of arrow b.

The leak hole 46d does not necessarily have to be formed. If the leak hole 46d is not formed, for example, as described below, a projecting part 64 with projection amount t may be formed on the facing surface 46a of the armature 46 to form a gap between the facing surface 46a of the armature 46 and the facing surface 42a of the stator core 42, and the leakage may flow out through this gap to the outlet 34.

The back side 46c of the armature 46 forms an inclined plane that slopes toward the stator core 42 as it extends from a radially inner side to a radially outer side of the armature 46. This reduces the volume and weight of the armature 46.

In the present embodiment, the outlet orifice 24 with a throttling function is provided as an opening communicating with the back pressure chamber P and opening to the second space S₂, but an opening without a throttling function may be formed.

In an embodiment, as shown in FIG. 2, the electromagnetic actuator 40 includes a second spring member 54. The second spring member 54 is configured to bias the armature 46 toward the stator core 42 along the axial direction and have a spring force such that the valve body 48 (protrusion 48c) closes the outlet orifice 24 and the facing surface 46a of the armature 46 is in contact with the flange part 50 in a state where the solenoid coil 44 is not energized.

In this embodiment, when the solenoid coil 44 is not energized, the spring force of the first spring member 52 is applied to the valve body 48 in the direction that the valve body 48 (protrusion 48c) closes the outlet orifice 24, so that the valve body 48 closes the outlet orifice 24. In addition to this, the spring force of the second spring member 54 pushes the armature 46 toward the stator core 42, so that the facing surface 46a of the armature facing the stator core 42 is in contact with a facing surface 50a of the flange part 50. When the solenoid coil 44 is energized in this state and an electromagnetic force is generated in the stator core 42, the armature 46 is attracted to the stator core 42, and this movement of the armature 46 is immediately transmitted to the flange part 50 to move the flange part 50 toward the stator core 42, allowing the valve body 48 to be actuated in the valve-opening direction without delay.

The embodiment illustrated in FIG. 2 has an anchor member 56 for stable support of the valve body 48. The anchor member 56 is disposed within the casing 12 on the side of the armature 46 opposite from the stator core 42 in the axial direction, and has a second through hole 56a extending along the axial direction.

The valve body 48 has a shaft part 48a extending along the axial direction, and a portion of the shaft part 48a protruding from the first through hole 46b toward the side opposite from the stator core 42 is slidably inserted into the second through hole 56a. The second spring member 54 is disposed between the back side 46c of the armature 46 opposite to the facing surface 46a and the stepped part 56c formed on the outer peripheral surface 56b of the anchor member 56.

According to this embodiment, since the shaft part 48a of the valve body 48 protruding from the first through hole 46b toward the side opposite from the stator core 42 is inserted into the second through hole 56a of the anchor member 56 and is slidably supported by the anchor member 56, the valve body 48 is stably supported by the anchor member 56. Additionally, since the second spring member 54 is disposed between the back side 46c of the armature 46 opposite to the facing surface 46a and the stepped part 56c formed on the outer peripheral surface 56b of the anchor member 56, it is stably supported between the armature 46 and the anchor member 56 and also exactly exerts a spring force on the armature 46 along the axial direction of the valve body 48.

In the embodiment illustrated in FIG. 2, the anchor member 56 has a reduced diameter part 56d centered on the axis O and extending from the back side 46c toward the anchor member 56 side. The anchor member 56 has a reduced diameter part 46e centered on the axis O and located on the armature 46 side in the axial direction. The second spring member 54 is configured as a coil spring arranged around the shaft part 48a of the valve body 48 and the reduced diameter parts 46e and 56d. The second spring member 54 configured as a coil spring is easy to place around the reduced diameter parts 46e and 56d.

Further, the armature 46 has an annular flat surface 46f formed radially inward of the back side 46c and around the reduced diameter part 46e in parallel to the facing surface 46a (i.e., perpendicular to the axis O) so as to surround the reduced diameter part 46e. Since one end of the second spring member 54 is arranged to be engaged with the flat surface 46f, this spring member is stably supported by the flat surface 46f. The outer peripheral surface 56b of the anchor member 56, the outer shape of the reduced diameter part 46e, and the outer shape of the reduced diameter part 56d of the anchor member 56 have a circular shape, which facilitates the placement of the second spring member 54 configured as a coil spring.

Additionally, in the embodiment illustrated in FIG. 2, the anchor member 56 has an enlarged diameter part 56e, which is formed on the axially opposite side from the armature 46, has a diameter even larger than the outer peripheral surface 56b, and is formed integrally with the anchor member 56. Further, an annular retaining nut 58 is disposed radially outward of the anchor member 56 so as to surround the anchor member 56, and the outer peripheral surface of the retaining nut 58 is screwed with the inner peripheral surface of the casing 12. The anchor member 56 is stably supported within the casing 12 by the retaining nut 58. In the enlarged diameter part 56e, a fuel passage 60 communicating with the fuel passage 14 is formed. The fuel passage 60 communicates with the outlet orifice 24 through the back pressure chamber P.

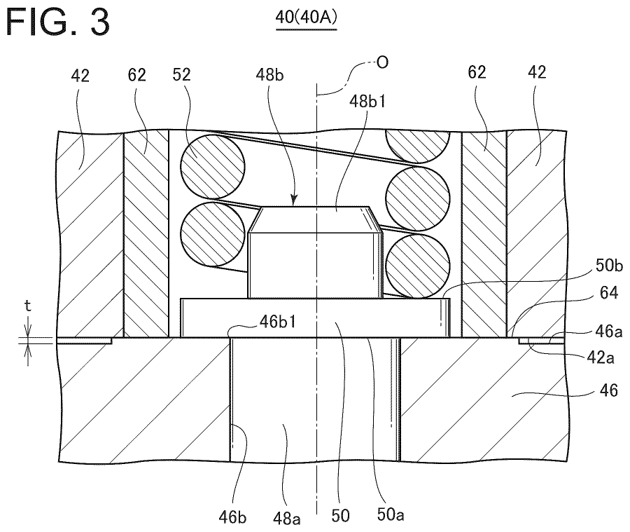

FIG. 3 is a partial enlarged longitudinal cross-sectional view of an electromagnetic actuator 40A according to an embodiment.

As shown in FIG. 3, the electromagnetic actuator 40A according to this embodiment has a first spring member 52 that is disposed radially inward of the stator core 42, extends along the axial direction, and faces the flange part 50.

In the embodiment illustrated in FIG. 3, the first spring member 52 is configured as a coil spring, and the axial end of the coil spring is disposed in contact with a facing surface 50b of the flange part 50.

A cylindrical frame 62 extending along the axial direction is disposed radially outward of the first spring member 52 and radially inward of the stator core 42 so as to surround the first spring member 52. The facing surface 46a of the armature 46 has a projecting part 64 formed to protrude from the facing surface 46a toward the stator core 42 in a position facing the end face of the frame 62.

In the electromagnetic actuator 40A, since the projecting part 64 is formed on the facing surface 46a, the projecting part 64 comes into contact with the stator core 42 in valve-opening motion of the valve body 48. Therefore, the contact area where the armature 46 comes into contact with the stator core 42 can be limited to the projecting part 64. If there is variation in the portion of the armature 46 that comes into contact with the facing surface 42a of the stator core 42, there is a risk that the timing at which the armature 46 comes into contact with the stator core 42 may vary. In this embodiment, the contact area where the armature 46 comes into contact with the stator core 42 is limited to the projecting part 64, which makes it easier to control the valve-opening motion of the valve body 48.

Additionally, since the projecting part 64 contacts the end surface of the frame 62 rather than the stator core 42, which is made of magnetic material, wear of the stator core 42 can be reduced. Furthermore, since the projecting part 64 can be formed from the end surface of the frame 62 toward the radially inner side of the armature 46, the timing at which the armature 46 comes into contact with the stator core 42 is less affected by the inclination of the facing surface 46a of the armature 46 with respect to the horizontal direction.

In the embodiment shown in FIG. 3, the first spring member 52 is configured as a coil spring, and this coil spring is arranged to surround the cylindrical reduced diameter part 48b1 so that its axis coincides with the axis O. Further, the frame 62 has a cylindrical shape, extends along the axial direction, and is arranged so that its axis coincides with the axis O. As described above, the first spring member 52 is arranged to surround the reduced diameter part 48b1 and is positioned such that the small-diameter portion 48b1 enters the internal space of the spring, thereby facilitating positioning of the first spring member 52.

Furthermore, the projecting part 64 has a flat surface that protrudes toward the stator core 42 by t from the facing surface 46a of the armature 46. In the embodiment illustrated in FIG. 3, the projecting part 64 is formed not only in a region in contact with the frame 62, but also in a region in contact with the facing surface 50a of the flange part 50 that faces the facing surface 46a of the armature 46. In other words, in the embodiment illustrated in FIG. 3, the projecting part 64 is formed in a region extending radially outward from the upper edge 46b1 of the first through hole 46b and facing the end surface of the frame 62.

The projecting part 64 is formed so as to have a uniform protrusion amount t throughout the entire region. Therefore, once the protrusion amount t of the projecting part 64 is determined, the clearance between the facing surface 46a of the armature 46 and the facing surface 42a of the stator core 42 is determined, eliminating the need to manage this clearance separately. For example, the protrusion amount t may be micron-order height.

In another embodiment, the projecting part 64 may be formed only in a region of the facing surface 46a of the armature 46 that comes into contact with the end surface of the frame 62.

By forming the projecting part 64, a gap is formed between the facing surface 42a of the stator core 42 and the facing surface 46a of the armature 46. This prevents poor response due to residual magnetism in the armature 46 after de-energizing the solenoid coil 44. Therefore, when the solenoid coil 44 is de-energized, the armature 46 can immediately begin to move away from the facing surface 42a of the stator core 42.

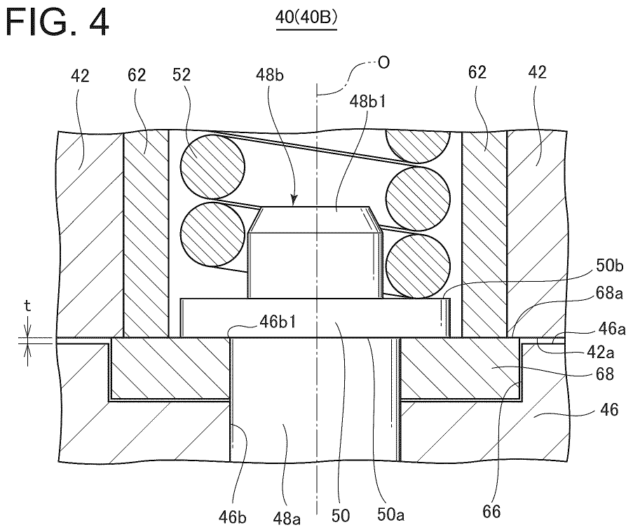

FIG. 4 is a partial enlarged longitudinal cross-sectional view of an electromagnetic actuator 40B according to another embodiment. In this embodiment, the first spring member 52 is disposed radially inward of the stator core 42, extends along the axial direction, and faces the flange part 50. A cylindrical frame 62 extending along the axial direction is disposed radially outward of the first spring member 52 and radially inward of the stator core 42 so as to surround the first spring member 52. Further, an annular recessed part 66 is formed in the facing surface 46a that faces the frame 62, and a spacer 68 is fitted in the recessed part 66. A facing surface 68a of the spacer 68 that faces the stator core 42 protrudes from the facing surface 46a of the armature 46 by t toward the stator core 42, and the facing surface 68a of the spacer 68 faces the axial end surface of the frame 62.

According to this embodiment, the facing surface 68a of the spacer 68 protrudes from the facing surface 46a of the armature 46 by t toward the stator core 42, so that the contact area where the armature 46 comes into contact with the stator core 42 during valve-opening operation can be limited to the facing surface 68a of the spacer 68. This eliminates variation in the timing at which the armature 46 comes into contact with the stator core 42, which makes it easier to control the valve-opening motion of the valve body 48. Additionally, since the spacer 68 contacts the end surface of the frame 62 rather than the stator core 42, which is made of magnetic material, wear of the stator core 42 can be reduced. Furthermore, since the spacer 68 is formed in a position facing the frame 62, it can be formed in a region radially inward of the facing surface 46a of the armature 46. Therefore, the timing at which the armature 46 comes into contact with the stator core 42 is less affected by the inclination of the armature 46 with respect to the horizontal direction.

In the embodiment illustrated in FIG. 4, the recessed part 66 is formed not only in a region of the facing surface 46a of the armature 46 that is in contact with the frame 62, but also extends to the radially inner region and reaches the first through hole 46b. In other words, the spacer 68 is formed in a region extending radially outward from the upper edge 46b1 of the first through hole 46b and facing the end surface of the frame 62. The spacer 68 is also annularly formed in conformity with the shape of the recessed part 66 to fill the entire area formed by the recessed part 66, and the inner peripheral surface of the spacer 68 is opposite and adjacent to the outer peripheral surface of the shaft part 48a. According to this embodiment, since the recessed part 66 extends up to the first through hole 46b, the recessed part 66 can be easily machined.

The recessed part 66 need only be formed at least in the facing surface 46a that comes into contact with the end surface of the frame 62, and the spacer 68 need only be formed to fit into such an annular recessed part.

In the embodiment illustrated in FIG. 4, the outer peripheral surface of the recessed part 66 has a circular shape, and the bottom surface forms a flat surface having a uniform depth across the radial direction as a whole. The recessed part 66 of such a shape can be easily machined. It is also easy to manufacture the spacer 68 in conformity with this shape.

In an exemplary embodiment, the spacer 68 is removably fitted into the recessed part 66. This allows the spacer 68 to be replaced with a new spacer when it exceeds a certain allowable amount of wear.

Further, if the spacer 68 is made of a material that has better wear resistance than the armature 46, which is made of magnetic material, wear of the spacer 68 can be reduced.

The contents described in the above embodiments would be understood as follows, for instance.
1) An electromagnetic actuator according to one aspect is an electromagnetic actuator (40) installed in a fuel injection device (10), including: a stator core (42) which is disposed within a casing (12) of the fuel injection device (10) and has a built-in coil (44) for generating a magnetic flux when energized; an armature (46) which has a facing surface (46a) disposed to face one end surface (42a) of the stator core (42) in an axial direction of the casing (12) and has a first through hole (46b) extending along the axial direction, the armature (46) being capable of reciprocating along the axial direction depending on the presence or absence of electromagnetic force generated from the stator core (42); a valve body (48) which is inserted into the first through hole (46b) and has a flange part (50) formed at a protruding part (48b) protruding from the first through hole (46b) toward the stator core (42) with a larger diameter than that of the first through hole (46b), the valve body (48) being capable of opening and closing an outlet port (24) of a back pressure chamber (P) formed in the casing (12); and a first spring member (52) which biases the valve body (48) along the axial direction in a direction that closes the outlet port (24). The valve body (48) is disposed slidably along the axial direction in a state where the valve body (48) is inserted into the first through hole (46b). The electromagnetic actuator (40) is configured such that, when the armature (46) moves toward the stator core (42) along the axial direction, the facing surface (46a) of the armature (46) comes into contact with the flange part (50), whereby the valve body (48) is moved in a direction that opens the outlet port (24).

With this configuration, when the coil (44) is not energized, the valve body (48) closes the outlet port (24) by the spring force of the first spring member (52) applied to the valve body (48). When the coil (44) is energized in this state, an electromagnetic force is generated in the stator core (42), which attracts the armature (46) toward the stator core (42). When the armature (46) is attracted toward the stator core (42), the armature (46) comes into contact with the flange part (50) and brings the flange part (50) toward the stator core (42), so that the valve body (48) integrated with the flange part (50) is actuated to open the outlet port (24) against the spring force of the first spring member (52). At that time, even if the armature (46) comes into contact with the stator core (42) and receives a repulsive force to move abruptly away from the stator core (42), the valve body (48) can slide freely along the axial direction with respect to the armature (46) in a state where it is inserted into the first through hole (46b). This prevents the valve body (48) from moving abruptly to close the valve in conjunction with the armature (46). Therefore, it is possible to suppress the deterioration of fuel injection controllability.
2) An electromagnetic actuator (40) according to another aspect is the electromagnetic actuator (40) as defined in 1), further including a second spring member (54) which biases the armature (46) along the axial direction in a direction toward the stator core (42). The second spring member (54) is configured to have a spring force such that the valve body (48) closes the outlet port (24) and the facing surface (46a) of the armature (46) is in contact with the flange part (50) in a state where the coil (44) is not energized.

With this configuration, when the coil (44) is not energized, the valve body (48) is urged to close the outlet port (24) by the spring force of the first spring member (52), while the armature (46) is brought close to the stator core (42) and the facing surface (46a) of the armature (46) facing the stator core (42) is brought into contact with the flange part (50) by the spring force of the second spring member (54) applied to the armature (46). When the coil (44) is energized in this state, an electromagnetic force is generated in the stator core (42), and when the armature (46) is attracted to the stator core (42) by this electromagnetic force, the movement of the armature (46) is immediately transmitted to the flange part (50) to move the flange part (50), allowing the valve body (48) integrated with the flange part (50) to be actuated in the valve-opening direction without delay.
3) An electromagnetic actuator (40A) according to yet another aspect is the electromagnetic actuator (40) as defined in 1) or 2), in which the first spring member (52) is disposed radially inward of the stator core (42), extends along the axial direction, and faces the flange part (50). The electromagnetic actuator (40A) further includes a cylindrical frame (64) disposed between the first spring member (52) and the stator core (42), extending along the axial direction, and surrounding the first spring member (52). The facing surface (46a) of the armature (46) has a projecting part (64) formed in a position facing an end surface of the frame (62) so as to protrude from the facing surface (46a) toward the stator core (42).

With this configuration, the contact area where the armature (46) comes into contact with the stator core (42) can be limited to the projecting part (64). If there is variation in the portion of the armature (46) that comes into contact with the stator core (42), there is a risk that the timing at which the armature (46) comes into contact with the stator core (42) may vary. With the above configuration, the contact area where the armature (46) comes into contact with the stator core (42) is limited to the projecting part (64), which makes it easier to control the valve-opening motion of the valve body (48). Additionally, since the projecting part (64) contacts the end surface of the frame (62) rather than the stator core (42), which is made of magnetic material, wear of the stator core (42) can be reduced. Furthermore, since the projecting part (64) is formed in a position facing the frame (62), it can be formed radially inward of the armature (46). Therefore, compared to the case where the projecting part (64) is formed on a radially outer side of the armature (46), the timing at which the armature (46) comes into contact with the stator core (42) is less affected by the inclination of the armature (46) with respect to the horizontal direction.
4) An electromagnetic actuator (40B) according to yet another aspect is the electromagnetic actuator (40) as defined in 1) or 2), in which the first spring member (52) is disposed radially inward of the stator core (42), extends along the axial direction, and faces the flange part (50). The electromagnetic actuator (40B) further includes: a cylindrical frame (64) disposed between the first spring member (52) and the stator core (42), extending along the axial direction, and surrounding the first spring member (52); and an annular spacer (68) fitted into an annular recessed part (66) formed in the facing surface (46a) of the armature (46), the spacer (68) protruding from the facing surface (46a) of the armature (46) toward the stator core (42) at least in a position facing an end surface of the frame.

With this configuration, the contact area where the armature (46) comes into contact with the stator core (42) during valve-opening operation is limited to the spacer (68). This eliminates variation in the timing at which the armature (46) comes into contact with the stator core (42), which makes it easier to control the valve-opening motion of the valve body (48). Additionally, since the spacer (68) contacts the frame (62) rather than the stator core (42), which is made of magnetic material, wear of the stator core (42) can be reduced. Furthermore, since the spacer (68) is formed in a position facing the frame (62), it can be formed radially inward of the armature (46). Therefore, compared to the case where the spacer (68) is formed on a radially outer side of the armature (46), the timing at which the armature (46) comes into contact with the stator core (42) is less affected by the inclination of the armature (46) with respect to the horizontal direction.
5) An electromagnetic actuator (40) according to yet another aspect is the electromagnetic actuator (40) as defined in 2), further including an anchor member (56) which is disposed within the casing (12) on a side of the armature (46) opposite from the stator core (42), the anchor member (56) having a second through hole (56a) which extends along the axial direction and into which a shaft part (48a) of the valve body (48) protruding from the first through hole (46b) toward a side opposite from the stator core (42) is inserted. The second spring member (54) is disposed between a surface (46c) of the armature (46) opposite to the facing surface (46a) and a stepped part (56c) formed on an outer peripheral surface (56b) of the anchor member (56).

With this configuration, since the shaft part (48a) of the valve body (48) protruding from the first through hole (46b) toward the side opposite from the stator core (42) is inserted into the second through hole (56a) of the anchor member (56) and is slidably supported by the anchor member (56), the valve body (48) is stably supported by the anchor member (56) while performing valve-opening motion and valve-closing motion. Additionally, since the second spring member (54) is disposed between the surface (56c) of the armature (46) opposite to the facing surface (46a) and the stepped part (56c) formed on the outer peripheral surface (56b) of the anchor member (56), it is stably supported between the armature (46) and the anchor member (56) and also exactly exerts a spring force on the armature (46) along the axial direction of the valve body (48).
6) A fuel injection device (10) according to one aspect includes the electromagnetic actuator (40) as defined in any of 1) to 5).

With this configuration, since the fuel injection device according to one aspect of the present disclosure includes the electromagnetic actuator (40) having the above configuration, even when the coil (44) is energized to inject fuel from the fuel injection hole (22) into the combustion chamber, and the armature (46) comes into contact with the stator core (42) and receives from the stator core (42) a repulsive force that causes the armature (46) to move abruptly away from the stator core (42), the valve body (48) inserted into the first through hole (46b) can slide freely along the axial direction with respect to the armature (46). This prevents the valve body (48) from moving abruptly to close the valve in conjunction with the armature (46). Therefore, it is possible to suppress the deterioration of fuel injection controllability.

### REFERENCE SIGNS LIST

10 Fuel injection device
12 Casing
12a Partition wall
14 (14a, 14b), 60 Fuel passage
16 Spool
18 Piston
20 Needle valve
22 Injection hole
24 Outlet orifice (Outlet port)
25 Inlet orifice
26 Spring member
28 Stepped part
30 Support base
32 Leak passage
34 Outlet
40 (40A, 40B) Electromagnetic actuator
42 Stator core
42a Facing surface
44 Solenoid coil
46 Armature
46a Facing surface
46b First through hole
46b1 Upper edge
46c Back side
46d Leak hole
46e Reduced diameter part
46f Flat surface
48 Valve body
48a Shaft part
48b Protruding part
48b1 Reduced diameter part
48c Protrusion
50 Flange part
50a, 50b Facing surface
52 First spring member
54 Second spring member
56 Anchor member
56a Second through hole
56b Outer peripheral surface
56c Stepped part
56d Reduced diameter part
56e Enlarged diameter part
58 Retaining nut
62 Frame
64 Projecting part
66 Recessed part
68 Spacer
68a Facing surface
O Axis
P Back pressure chamber
S₁ First space
S₂ Second space
f1, f2, f3 Peak
t Protrusion amount

1. An electromagnetic actuator installed in a fuel injection device, comprising:
a stator core which is disposed within a casing of the fuel injection device and has a built-in coil for generating a magnetic flux when energized;
an armature which has a facing surface disposed to face one end surface of the stator core in an axial direction of the casing and has a first through hole extending along the axial direction, the armature being capable of reciprocating along the axial direction depending on the presence or absence of electromagnetic force generated from the stator core;
a valve body which is inserted into the first through hole and has a flange part formed at a protruding part protruding from the first through hole toward the stator core with a larger diameter than that of the first through hole, the valve body being capable of opening and closing an outlet port of a back pressure chamber formed in the casing; and
a first spring member which biases the valve body along the axial direction in a direction that closes the outlet port,
wherein the valve body is disposed slidably along the axial direction in a state where the valve body is inserted into the first through hole, and
wherein the electromagnetic actuator is configured such that, when the armature moves toward the stator core along the axial direction, the facing surface of the armature comes into contact with the flange part, whereby the valve body is moved in a direction that opens the outlet port.

2. The electromagnetic actuator according to claim 1, further comprising a second spring member which biases the armature along the axial direction in a direction toward the stator core,
wherein the second spring member is configured to have a spring force such that the valve body closes the outlet port and the facing surface of the armature is in contact with the flange part in a state where the coil is not energized.

3. The electromagnetic actuator according to claim 1,
wherein the first spring member is disposed radially inward of the stator core, extends along the axial direction, and faces the flange part,
wherein the electromagnetic actuator further comprises a cylindrical frame disposed between the first spring member and the stator core, extending along the axial direction, and surrounding the first spring member, and
wherein the facing surface of the armature has a projecting part formed in a position facing an end surface of the frame so as to protrude from the facing surface toward the stator core.

4. The electromagnetic actuator according to claim 1,
wherein the first spring member is disposed radially inward of the stator core, extends along the axial direction, and faces the flange part,
wherein the electromagnetic actuator further comprises:
a cylindrical frame disposed between the first spring member and the stator core, extending along the axial direction, and surrounding the first spring member; and
an annular spacer fitted into an annular recessed part formed in the facing surface of the armature, the spacer protruding from the facing surface of the armature toward the stator core at least in a position facing an end surface of the frame.

5. The electromagnetic actuator according to claim 2, further comprising an anchor member which is disposed within the casing on a side of the armature opposite from the stator core, the anchor member having a second through hole which extends along the axial direction and into which a shaft part of the valve body protruding from the first through hole toward a side opposite from the stator core is inserted,
wherein the second spring member is disposed between a surface of the armature opposite to the facing surface and a stepped part formed on an outer peripheral surface of the anchor member.

6. A fuel injection device, comprising
the electromagnetic actuator according to claim 1.
